(19) United States
(12) Patent Application Publication
(10) Pub. No.: US 2005/0150259 A1
(43) Pub. Date: Jul. 14, 2005

(54) Washing machine

(76) Inventors: Sung Gi Hwang, Changwon-si (KR); Jeung Gie Ahn, Seoul (KR); Il Tak Han, Suwon-si (KR)

Correspondence Address: MCKENNA LONG & ALDRIDGE LLP, 1900 K STREET, NW, WASHINGTON, DC, 20006, US

(21) Appl. No.: 11/023,598

(22) Filed: Dec. 29, 2004

(30) Foreign Application Priority Data
Dec. 29, 2003 (KR) P 2003-98959
Dec. 29, 2003 (KR) P 2003-98960
Dec. 29, 2003 (KR) P 2003-98961
Dec. 29, 2003 (KR) P 2003-98962

(51) Int. Cl. B08B 3/12; D06F 37/00; D06F 21/00

(52) U.S. Cl. 68/3 R

(57) ABSTRACT

Washing machine including one pair of side covers for covering sides of the washing machine, a back cover for covering a back side of the washing machine, a first flange portion bent either from a rear edge of the side cover or a side edge of the back cover substantially at a right angle, and at least one joint portion at overlap portions between the first flange portion and a mating side of the first flange portion, the joint portion being joined by Tox round joint, thereby permitting easy assembly of the cabinet.

### CROSS-REFERENCE TO RELATED APPLICATIONS

This application claims the benefit of Korean Application Nos. P2003-0098959, P2003-0098960, P2003-0098961, P2003-0098962, all of which were filed on Dec. 29, 2003, and are hereby incorporated by reference as if fully set forth herein.

### BACKGROUND OF THE INVENTION

1. Field of the Invention

The present invention relates to washing machines, and more particularly, to a washing machine having a cabinet which can be assembled easily.

2. Discussion of the Related Art

In general, the washing machine is provided with a cabinet forming an exterior of the washing machine, and a drum rotatably mounted in the cabinet. The drum is driven by a driving unit, for removing dirt stuck to laundry by friction between the washing water held in the drum and the laundry, and a chemical action.

Since a drum type washing machine, with the drum laid horizontally, can reduce a height compared to a pulsator type washing machine in which the drum is upstanding. Moreover, the drum type washing machine can have an increased capacity, and prevent entangling of laundry. According to this, demands for the drum type washing machine is increasing, recently.

In the meantime, currently, a drying and washing machine is fabricated, in which a heater is provided in the drum of the drum type washing machine for supplying heated air to an inside of the drum, for drying the laundry of which washing is completed.

FIG. 1 illustrates a perspective view of an exterior of a related art drum type washing machine.

Referring to FIG. 1, there is a cabinet 100 of the washing machine having a drum, a driving unit, and a heater provided therein. The drum of a cylindrical shape holding washing water and laundry is rotated by the driving unit. The laundry is washed by friction between water circulation and laundry, and a softening action of detergent.

After finish of the washing, air heated by the heater is supplied to an inside of the drum. The heated air is supplied to the drum through a supply flow passage, and discharged from the drum to an outside of the drum through a discharge flow passage. The discharge flow passage has a fan for blowing the heated air.

In the meantime, the cabinet 100 covers sides, a bottom, and a rear of the washing machine, and a cabinet cover 10 is provided to a front of the washing machine having an opening for introduction of the laundry. There is a top plate 20 covering a top of the washing machine, and between an upper end of the cabinet cover 10 and the top plate 20, there is a control panel 30 having various control buttons provided thereto. For opening/closing the opening, there is a door 12 rotatably mounted on the cabinet cover 10.

FIG. 2 illustrates a perspective view showing an assembling structure of the cabinet.

Referring to FIG. 2, the cabinet 100 is provided with a base 130, side covers 110, and a back cover 120. The base 130 is at a bottom of the washing machine, and the back cover 120 is at the rear of the washing machine. The side covers 110 are at sides of the back cover 120.

As shown, plates of the base 130, the back cover 120, and the side covers 10 are joined by curling with each other. That is, mating edges of the plates are joined with each other by curling.

However, the assembling structure of the related art drum type washing machine has the following problems.

First, in a case the edges of the plates are curled, it is difficult to make curling at ends of joining due to interference of neighboring structure, to make an exterior of the cabinet to appear not smooth.

Second, there is spring back occurred upon removal of a force from the plate after application of the force for bending the plate in the curling, such that some amount of a bent portion returns to an original position, to reduce the bent portion. If the spring back is extensive such that an assembly tolerance between the side cover and the back cover is outside of an allowable range, there can be defect occurred in assembling the cabinet, to require to extend an assembling time period.

Third, the loading, and pressing of the plates at an exact position, and many manual works such as at corners in the curling requires a long working time period.

### SUMMARY OF THE INVENTION

Accordingly, the present invention is directed to a washing machine that substantially obviates one or more problems due to limitations and disadvantages of the related art.

An object of the present invention is to provide a washing machine which is easy to assemble.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing machine includes one pair of side covers for covering sides of the washing machine, a back cover for covering a back side of the washing machine, a first flange portion bent either from a rear edge of the side cover or a side edge of the back cover substantially at a right angle, and at least one joint portion at overlap portions between the first flange portion and a mating side of the first flange portion, the joint portion being joined by Tox round joint.

The overlap portion of the first flange portion is bent to form a step projected forward. The overlap portion of the mating side of the first flange portion is bent to form a step projected backward.

Preferably, the first flange portion is at a rear edge of the side cover. The overlap portion of the first flange portion is bent to form a step projected forward. The side edges of the back cover are bent to form steps projected backward, respectively. The side edges of the back cover are joined to rear sides of the first flange portions, respectively.

The Tox round joint presses the joint portion to be projected inward of the washing machine.

In another aspect of the present invention, a washing machine includes one pair of side covers for covering sides of the washing machine, a base for covering a bottom of the washing machine, a second flange portion bent either from a bottom edge of the side cover or a side edge of the base substantially at a right angle, and at least one joint portion at overlap portions between the second flange portion and a mating side of the second flange portion, the joint portion being joined by Tox round joint.

The overlap portion of the second flange portion is bent to form a step projected upward. The overlap portion of the mating side of the second flange portion is bent to form a step projected downward.

Preferably, the second flange portion is at the bottom edge of the side cover. The overlap portion of the second flange portion is bent to form a step projected upward. The side edges of the base are bent to form steps projected downward, respectively. The side edges of the base are joined to under sides of the second flange portions, respectively.

In another aspect of the present invention, a washing machine includes a back cover for covering a rear of the washing machine, a base for covering a bottom of the washing machine, a third flange portion bent either from a bottom edge of the back cover or a side edge of the base substantially at a right angle, and at least one joint portion at overlap portions between the third flange portion and a mating side of the third flange portion, the joint portion being joined by Tox round joint.

The overlap portion of the third flange portion is bent to form a step projected upward. The overlap portion of the mating side of the third flange portion is bent to form a step projected downward.

Preferably, the third flange portion is at the bottom edge of the back cover. The overlap portion of the third flange portion is bent to form a step projected upward. The side edges of the base are bent to form steps projected downward, respectively.

The side edges of the base are joined to under sides of the third flange portions, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a perspective view of an exterior of a related art drum type washing machine;

FIG. 2 illustrates a perspective view showing an assembling structure of a related art cabinet, with a partial section of key parts;

FIG. 3 illustrates a perspective view showing an assembling structure of a cabinet in accordance with a preferred embodiment of the present invention, with a partial section of key parts;

FIG. 4 illustrates a section showing a joint between a side cover and a back cover in accordance with the present invention;

FIGS. 5A and 5B explain Tox round joint applied to the present invention;

FIG. 6 illustrates a section of a joint between a side cover and a base; and

FIG. 7 illustrates a section of a joint between a back cover and a base.

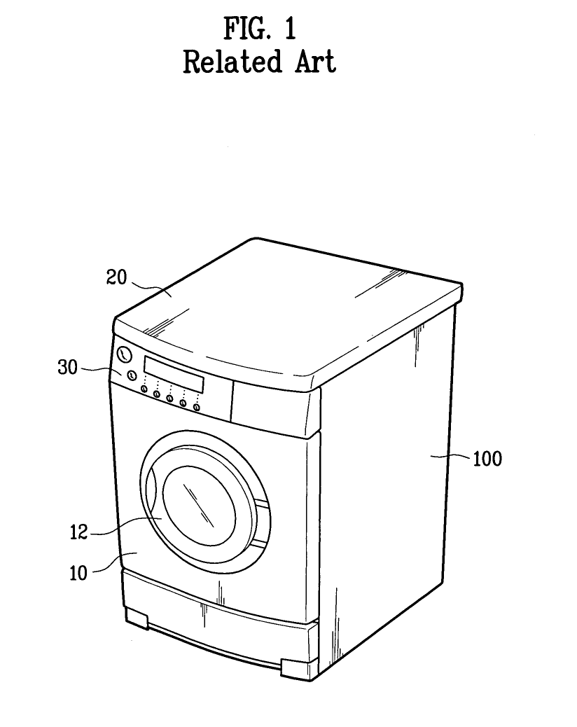

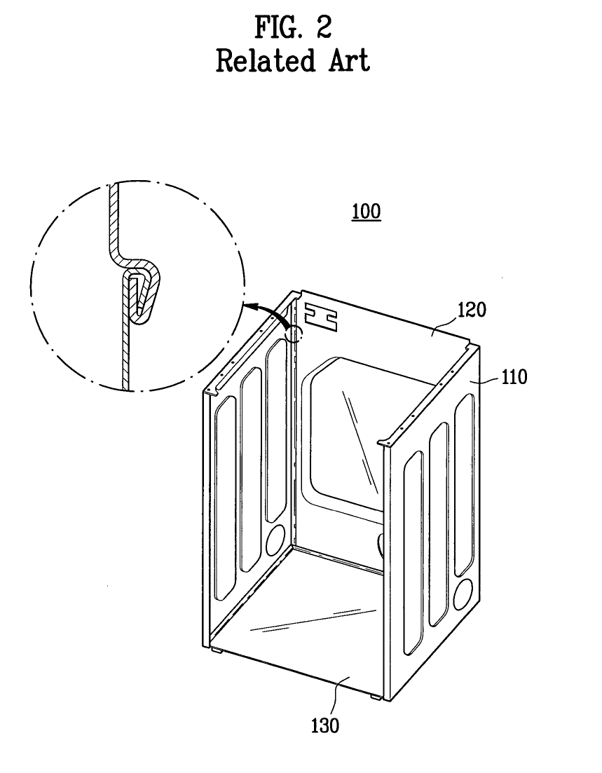

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

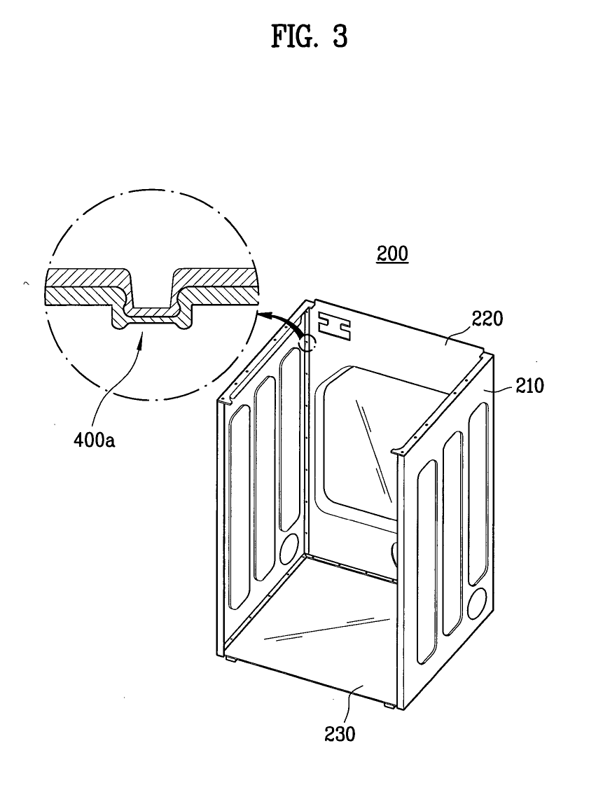

Embodiments of the present invention will be described with reference to FIGS. 3˜7.

FIG. 3 illustrates a perspective view showing an assembling structure of a cabinet in accordance with a preferred embodiment of the present invention, with a partial section of key parts.

The washing machine of the present invention has a drum in a cabinet mounted rotatable about a shaft horizontal to the ground. The drum is rotated by driving means. Laundry is washed by friction between the laundry and the washing water held in the drum and a softening action of detergent.

Referring to FIG. 3, the cabinet 200 includes one pair of side covers 210, a back cover 220, and a base 230. The side covers 210 cover sides of the washing machine, and the back cover 220 covers a rear of the washing machine. The base 230 is at a bottom of the washing machine.

The side covers 210, the back cover 220, and the base 230 are joined with Tox round joints.

Rear edges of the side covers 210 are joined with opposite edges of the back cover 220, and a bottom edge of the side covers 210 are joined with opposite edges of the base 230. A bottom edge of the back cover 220 is joined with a rear edge of the base 230.

A joining structure between the side covers 210 and the back cover 220 will be described.

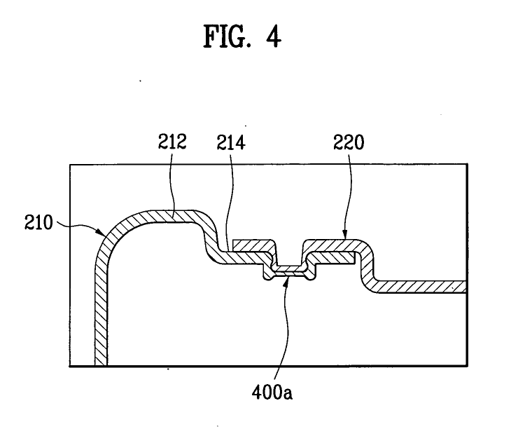

FIG. 4 illustrates a section showing a joint between a side cover 210 and a back cover 220 in accordance with the present invention.

There is a first flange portion 212 bent either from a rear edge of the side cover 210 or a edge of the back cover 220. If the first flange portion 212 is at the side cover 210, the first flange portion 212 is constructed of a portion of the rear edge of the side cover 210 bent inwardly substantially at a right angle. Opposite to this, if the first flange portion 212 is at the back cover 220, the first flange portion 212 is constructed of a portion of the edge of the back cover 220 bent forwardly substantially at a right angle.

Preferably, the first flange portion 212 is bent inward of the washing machine from the rear edge of the side cover 210. If the first flange portion 212 is bent projected outward, burr at the edge of the first flange portion can injure workers. In order to prevent such a problem, the first flange portion 212 is bent inward of the washing machine.

Referring to FIG. 4, the first flange portion 212 at the rear of the side cover 210 has a first stepped portion 214 at an overlap portion of the first flange portion 212 bent to form a step projected forward. A mating side of the first flange portion 212 is joined to a rear surface of the first stepped portion 214. It is preferable that the mating side of the first flange portion 212, i.e., an overlap portion at one of opposite edges of the back cover 220, is bent to form a stepped portion projected backward.

The opposite edges of the back cover 220 are respectively joined to the first flange portions 212 from a rear side thereof.

The stepped portions serve as bead for reinforcing a strength of the cabinet, and enables easy positioning of the back cover 220 at a joining position in rear of the first flange portion 212. That is, only positioning of the edges of the back cover 220 between the first stepped portions 214 at the first flange portions 214 is required for alignment to the joining position.

The overlap portions of the first flange portion 212 and the other side opposite to the first flange portion 212 are joined with a Tox round joint. The Tox round joint enables easy joining of to different plates.

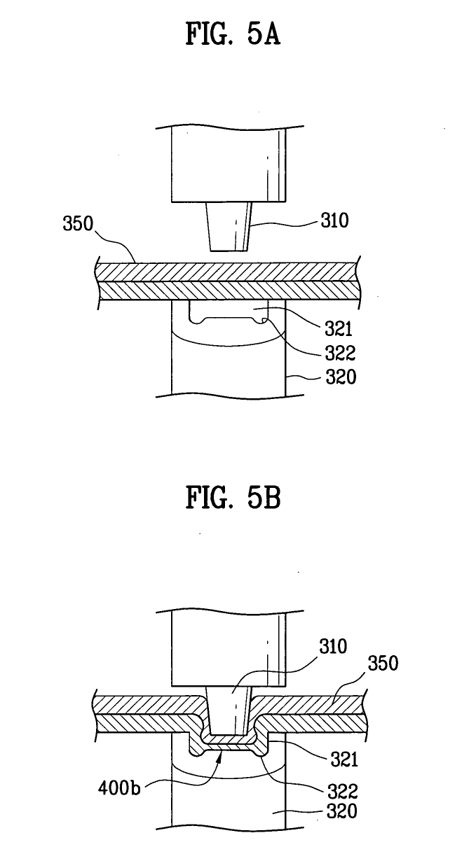

FIGS. 5A and 5B explain Tox round joint applied to the present invention.

A press punch 310 of a truncated cone is provided on one side of contact portions of plates to be joined, and a press die 320 having a circular recess 321 is provided to the other side of the contact portions of plates. The circular recess 321 has a diameter slightly greater then a diameter of the press punch 310, and has a groove 322 along an edge of a bottom of the recess 321.

A joining method of the plates by the Tox round joint will be described.

Overlapped two plates are placed between the press punch 310 and the press die 320. Then, the press punch 310 presses one side of the overlapped plates toward the recess 321.

Referring to FIG. 5B, as a force applied to the plates increases, one side of the plates is involved in a plastic deformation, so as to be inserted into an inside of the recess, to form a joint portion 400. In the plastic deformation, the joint portion, a pressed portion of the plates, is joined together as the pressed portion forms a curved portion.

Referring to FIG. 4, the joint portion 400a, formed by the Tox round joint, has a portion projected to one side. In joining the side cover 210 to the back cover 220, it is preferable that the joint portion 400a is pressed so as to be projected inward of the washing machine. This is because the joint portion 400a projected outward makes the exterior poor, and interferes with things in the vicinity of the joint portion 400a during assembly of the washing machine.

Moreover, at least one joint portion is formed at fixed intervals along a length direction of the overlap portion of the first flange portion 212 and the first flange portion 212. The more a number of joint portions 400a, the greater a joint strength.

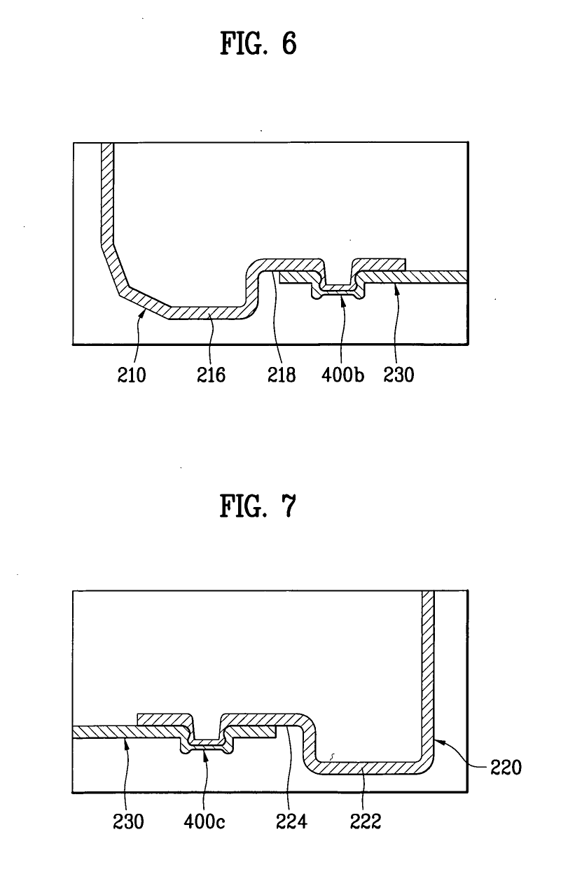

FIG. 6 illustrates a section of a joint between a side cover and a base.

There is a second flange portion 216 bent either from a bottom edge of the side cover 210 or a edge of the base 230. If the second flange portion 216 is at the side cover 210, the second flange portion 212 is constructed of a portion of the bottom edge of the side cover 210 bent inwardly substantially at a right angle. Opposite to this, if the second flange portion 216 is at the base 230, the second flange portion 216 is constructed of a portion of side edges of the base 230 bent upwardly substantially at a right angle.

Preferably, the second flange portion 216 is bent inward of the washing machine from the bottom edge of the side cover 210. If the second flange portion 216 is bent projected outward, burr at the edge of the second flange portion 216 can injure workers. In order to prevent such a problem, the second flange portion 216 is bent inward of the washing machine.

Referring to FIG. 6, the second flange portion 216 at the bottom of the side cover 210 has a second stepped portion 218 at an overlap portion of the second flange portion 216 bent to form a step projected upward. A mating side of the second flange portion 216 is joined to a bottom surface of the second stepped portion 218. It is preferable that the mating side of the second flange portion 216, i.e., an overlap portion at the edge of the base 230, is bent to form a stepped portion projected downward.

The stepped portions serve as beads for reinforcing a strength of the cabinet, and aligns a joining position of the base 230 to the second flange portion 216. That is, only positioning of the edges of the base 230 between the second stepped portions 216 at the second flange portions 214 is required for alignment to the joining position.

The side edges of the base 230 are joined to the bottom surfaces of the second flange portions 216. Leg assemblies at a bottom of the base 230 support a weight of the washing machine.

In the meantime, because the drum, the tub, and the driving unit are secured to inside surfaces of the side covers 210, weights of the units are placed on the side covers 210. Therefore, if the base 230 is joined to an upper surface of the second flange portions 216 at the bottom of the side covers 210, it is danger in that the side cover 210 and the base 230 are separated due to weights of the units. In order to prevent the danger from occurring, it is preferable that the side edges of the base 230 are joined to bottom surfaces of the second flange portions 216 at a bottom of the side covers 210. As described before, in a case the base 230 is joined to the bottom surfaces of the second flange portions 216, the weights prevent the separation of the side cover 210 from the base 230.

The overlap portions of the second flange portion 216 and the base 230 are joined with a Tox round joint. It is preferable that the joint portion 400b formed by the Tox round joint is projected downward at the time of joining of the side cover 210 and the back cover 220.

FIG. 6 illustrates a section of a joint between a back cover and a base.

There is a third flange portion 222 bent either from a bottom edge of the back cover 230 or a rear edge of the base 230. If the third flange portion 222 is at the back cover 220, the third flange portion 222 is constructed of a portion of the bottom edge of the back cover 220 bent inwardly substantially at a right angle. Opposite to this, if the third flange portion 222 is at the base 230, the third flange portion 222 is constructed of a portion of one of opposite edges of the base 230 bent upwardly substantially at a right angle.

Preferably, the third flange portion 222 is bent inward of the washing machine from the bottom edge of the back cover 220. If the third flange portion 222 is bent projected outward, burr at the edge of the third flange portion 222 can injure workers. In order to prevent such a problem, the third flange portion 222 is bent inward of the washing machine.

Referring to FIG. 7, the third flange portion 222 at the bottom of the back cover 220 has a third stepped portion 224 at an overlap portion of the third flange portion 222 bent to form a step projected upward. A mating side of the third flange portion 222 is joined to a bottom surface of the third stepped portion 224. It is preferable that the mating side of the third flange portion 222, i.e., an overlap portion at a rear edge of the base 230, is bent to form a stepped portion projected downward.

The stepped portions serve as beads for reinforcing strength of the cabinet, and aligns a joining position of the base 230 to the third flange portion 222. That is, only positioning of the opposite edges of the base 230 at the third stepped portions 224 at the third flange portions 224 is required for alignment to the joining position.

The rear edge of the base 230 is joined to the bottom surface of the third flange portions 222. Leg assemblies at a bottom of the base 230 support a weight of the washing machine.

In the meantime, because the drum, the tub, and the driving unit are secured to inside surfaces of the back cover 220, weights of the units are placed on the back cover 220. Therefore, if the base 230 is joined to an upper surface of the third flange portion 222 at the bottom of the back cover 220, it is dangerous in that the back cover 220 and the base 230 are separated due to weights of the units. In order to prevent the danger from occurring, it is preferable that the rear edge of the base 230 is joined to a bottom surface of the third flange portions 222 at a bottom of the back covers 220. As described before, in a case the base 230 is joined to the bottom surface of the third flange portion 222, the weights prevent the separation of the back cover 220 from the base 230.

The overlap portions of the third flange portion 222 and the base 230 are joined with a Tox round joint. It is preferable that the joint portion 400c formed by the Tox round joint is projected downward at the time of joining of the base 230 and the back cover 220.

As has been described, the washing machine of the present invention has the following advantages.

First, the Tox round joint between the plates of the cabinet permits to eliminate the necessity of curling of edges of the plates, thereby preventing an exterior of the cabinet from looking poor due to non-uniform curling.

Second, the prevention of occurrence of spring back at the time of curling by employing the Tox round joint permits more accurate and fast assembly of the plates.

Third, since the Tox round joint, in which two plates are overlapped, and pressed to join the two plate, requires a simple work without manual work, a working time period can be shortened.

Fourth, the stepped portions of the flange portions serve as beads that reinforce strength of the cabinet, as well as align the plates, thereby permitting an easy, and smooth assembly of the cabinet.

Even thought the present invention has been described with reference to a drum type washing machine, the cabinet is applicable to a drum type dryer. Moreover, it will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A washing machine comprising:
one pair of side covers for covering sides of the washing machine;
a back cover for covering a back side of the washing machine;
a first flange portion bent either from a rear edge of the side cover or a side edge of the back cover substantially at a right angle; and
at least one joint portion at overlap portions between the first flange portion and a mating side of the first flange portion, the joint portion being joined by Tox round joint.

2. The washing machine as claimed in claim 1, wherein the overlap portion of the first flange portion is bent to form a step projected forward.

3. The washing machine as claimed in claim 2, wherein the overlap portion of the mating side of the first flange portion is bent to form a step projected backward.

4. The washing machine as claimed in claim 1, wherein the first flange portion is at a rear edge of the side cover.

5. The washing machine as claimed in claim 4, wherein the overlap portion of the first flange portion is bent to form a step projected forward.

6. The washing machine as claimed in claim 5, wherein the side edges of the back cover are bent to form steps projected backward, respectively.

7. The washing machine as claimed in claim 5, wherein the side edges of the back cover are joined to rear sides of the first flange portions, respectively.

8. The washing machine as claimed in claim 1, wherein the Tox round joint presses the joint portion to be projected inward of the washing machine.

9. A washing machine comprising:
one pair of side covers for covering sides of the washing machine;
a base for covering a bottom of the washing machine;
a second flange portion bent either from a bottom edge of the side cover or a side edge of the base substantially at a right angle; and
at least one joint portion at overlap portions between the second flange portion and a mating side of the second flange portion, the joint portion being joined by Tox round joint.

10. The washing machine as claimed in claim 9, wherein the overlap portion of the second flange portion is bent to form a step projected upward.

11. The washing machine as claimed in claim 10, wherein the overlap portion of the mating side of the second flange portion is bent to form a step projected downward.

12. The washing machine as claimed in claim 9, wherein the second flange portion is at the bottom edge of the side cover.

13. The washing machine as claimed in claim 12, wherein the overlap portion of the second flange portion is bent to form a step projected upward.

14. The washing machine as claimed in claim 13, wherein the side edges of the base are bent to form steps projected downward, respectively.

15. The washing machine as claimed in claim 13, wherein the side edges of the base are joined to under sides of the second flange portions, respectively.

16. A washing machine comprising:
a back cover for covering a rear of the washing machine;
a base for covering a bottom of the washing machine;
a third flange portion bent either from a bottom edge of the back cover or a side edge of the base substantially at a right angle; and
at least one joint portion at overlap portions between the third flange portion and a mating side of the third flange portion, the joint portion being joined by Tox round joint.

17. The washing machine as claimed in claim 16, wherein the overlap portion of the third flange portion is bent to form a step projected upward.

18. The washing machine as claimed in claim 17, wherein the overlap portion of the mating side of the third flange portion is bent to form a step projected downward.

19. The washing machine as claimed in claim 16, wherein the third flange portion is at the bottom edge of the back cover.

20. The washing machine as claimed in claim 19, wherein the overlap portion of the third flange portion is bent to form a step projected upward.

21. The washing machine as claimed in claim 20, wherein the side edges of the base are bent to form steps projected downward, respectively.

22. The washing machine as claimed in claim 20, wherein the side edges of the base are joined to under sides of the third flange portions, respectively.
